(19) United States
(12) Patent Application Publication
(10) Pub. No.: US 2017/0011397 A1
(43) Pub. Date: Jan. 12, 2017

(54) METHOD AND SYSTEM FOR PERSON TO PERSON PAYMENTS USING A CONTROLLED PAYMENT NUMBER

(71) Applicant: MasterCard International Incorporated, Purchase, NY (US)

(72) Inventors: Deepankar BHAGAT, Chesterfield, MO (US); Michael D. McCARTHY, New York, NY (US); Lukas EKSELIUS, Overijse (BE); Mark N. SAVOYE, Hartsdale, NY (US)

(73) Assignee: MasterCard International Incorporated, Purchase, NY (US)

(21) Appl. No.: 14/794,147

(22) Filed: Jul. 8, 2015

(51) Int. Cl. G06Q 20/40; G06Q 20/06; G06Q 40/02

(52) U.S. Cl. CPC G06Q 20/405; G06Q 40/025; G06Q 20/065

(57) ABSTRACT

A method for processing transactions in user accounts includes: storing account profiles, each including data related to a user account of a non-financial institution (NFI) entity including a controlled payment number (CPN) and spending limit, the CPN being associated with a transaction account of the NFI entity and subject to the spending limit; receiving a transaction request including a payer CPN, payee CPN, and transaction amount; identifying a payer account profile that includes the payer CPN; identifying a payee account profile that includes the payee CPN; decreasing the spending limit included in the payer account profile based on the transaction amount; and increasing the spending limit included in the payee account profile based on the transaction amount.

### FIELD

The present disclosure relates to the crediting of user accounts and processing of transactions involving user accounts, specifically associating controlled payment numbers with use accounts of a non-financial institution entity and use thereof in person to person transactions.

### BACKGROUND

Non-financial institution (NFI) entities, particularly those with a heavy presence on the Internet and other types of communication networks that involve computing devices, may be associated with a significant number of users. Each of these users may have an account with the NFI entity, which may be used to engage in various services offered by the entity. For example, a social network may have users numbering in the hundreds of thousands, if not millions, and may provide the users with various tools for connecting with others, interacting socially, etc.

As part of the services provided to users, NFI entities may sometimes interact with, or provide for an avenue for users to interact with, a third party. For example, the NFI entity may make a deal with a merchant to offer discounts to the entity's users, which may be of mutual benefit to the NFI entity, the merchant, and the users that enjoy the discount. However, it may be difficult and cumbersome for a merchant to verify that a customer is a user of the NFI entity and eligible for a discount, which may dissuade both the merchant and users from taking advantage of the deal, thereby negating any benefit attempted by the NFI entity.

Some methods for providing users with such a service may involve collecting user payment information, and enabling the user to conduct transactions via the NFI entity. However, users may be wary of providing such sensitive data to the NFI entity. In addition, many NFI entities may lack the technical hardware and system security necessary to both store such information and communicate such information, which may require specialized protocols and communication technology. Another method may involve the establishing of payment accounts with the NFI entity, using a traditional flat currency or a specialized currency. However, this may require the entity to operate as a financial entity and regularly process payment transactions, which may be costly and require the entity to significantly modify their technical systems, business practices, licensing, etc.

Thus, there is a need for a technical system that can provide an NFI entity with the ability to enable users to conduct payment transactions, particularly person to person transactions, but without requiring the NFI entity to operate as a financial institution or to regularly conduct transactions using traditional payment systems. Some NFI entities have established virtual currencies in order to enable transactions among users. However, these currencies often may be unable to be used outside of the NFI entity, which may be limiting for users, and has historically resulted in low adoption and usage by users. Thus, there is a need for not only enabling users to conduct user to user transactions, but also to enable users to conduct transactions with outside entities, but without requiring the NFI entity to operate as a financial institution.

### SUMMARY

The present disclosure provides a description of systems and methods for providing credit for user accounts and processing user to user transactions via controlled payment numbers.

A method for providing credit for a user account includes: storing, in an account database, a plurality of account profiles, each account profile including data related to a user account of a non-financial institution (NFI) entity, said data including at least a controlled payment number and a spending limit, wherein the controlled payment number is associated with a transaction account of the corresponding NFI entity and is subject to the spending limit when used to fund a payment transaction; receiving, by a receiving device, a transaction message for a payment transaction, wherein the transaction message is formatted based on one or more payment network standards and includes a plurality of data elements including at least a first data element configured to store a transaction account number associated with the transaction account of the corresponding NFI entity and a second data element configured to store a transaction amount; identifying, by a processing device, a specific account profile stored in the account database; and increasing, by the processing device, the spending limit included in the identified specific account profile based on the transaction amount of the second data element included in the received transaction message.

A method for processing transactions in user accounts includes: storing, in an account database, a plurality of account profiles, each account profile including data related to a user account of a non-financial institution (NFI) entity, said data including at least a controlled payment number and a spending limit, wherein the controlled payment number is associated with a transaction account of the corresponding NFI entity and is subject to the spending limit when used to fund a payment transaction; receiving, by a receiving device, a transaction request, wherein the transaction request includes at least a payer controlled payment number, a payee controlled payment number, and a transaction amount; identifying, by a processing device, a payer account profile stored in the account database where the included controlled payment number corresponds to the payer controlled payment number included in the received transaction request; identifying, by the processing device, a payee account profile stored in the account database where the included controlled payment number corresponds to the payee controlled payment number included in the received transaction request; decreasing, by the processing device, the spending limit included in the identified payer account profile based on the transaction amount included in the received transaction request; and increasing, by the processing device, the spending limit included in the identified payee account profile based on the transaction amount included in the received transaction request.

A system for providing credit for a user account includes an account database, a receiving device, and a processing device. The account database is configured to store a plurality of account profiles, each account profile including data related to a user account of a non-financial institution (NFI) entity, said data including at least a controlled payment number and a spending limit, wherein the controlled payment number is associated with a transaction account of the corresponding NFI entity and is subject to the spending limit when used to fund a payment transaction. The receiving device is configured to receive a transaction message for a payment transaction, wherein the transaction message is formatted based on one or more payment network standards and includes a plurality of data elements including at least a first data element configured to store a transaction account number associated with the transaction account of the corresponding NFI entity and a second data element configured to store a transaction amount. The processing device is configured to: identify a specific account profile stored in the account database; and increase the spending limit included in the identified specific account profile based on the transaction amount stored in the second data element included in the received transaction message.

A system for processing transactions in user accounts includes an account database, a receiving device, and a processing device. The account database is configured to store a plurality of account profiles, each account profile including data related to a user account of a non-financial institution (NFI) entity, said data including at least a controlled payment number and a spending limit, wherein the controlled payment number is associated with a transaction account of the corresponding NFI entity and is subject to the spending limit when used to fund a payment transaction. The receiving device is configured to receive a transaction request, wherein the transaction request includes at least a payer controlled payment number, a payee controlled payment number, and a transaction amount. The processing device is configured to: identify a payer account profile stored in the account database where the included controlled payment number corresponds to the payer controlled payment number included in the received transaction request; identify a payee account profile stored in the account database where the included controlled payment number corresponds to the payee controlled payment number included in the received transaction request; decrease the spending limit included in the identified payer account profile based on the transaction amount included in the received transaction request; and increase the spending limit included in the identified payee account profile based on the transaction amount included in the received transaction request.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for processing transactions involving user accounts with a non-financial institution entity using controlled payment numbers in accordance with exemplary embodiments.

FIG. 2 is a block diagram illustrating the processing server of FIG. 1 for crediting user accounts and processing transactions involving user accounts in accordance with exemplary embodiments.

FIGS. 3A and 3B are a flow diagram illustrating a processing flow for the crediting of a user account associated with a controlled payment number in accordance with exemplary embodiments.

FIGS. 4A and 4B are a flow diagram illustrating a processing flow for processing a transaction involving a user account and a third party merchant in accordance with exemplary embodiments.

FIG. 5 is a flow diagram illustrating a processing flow for processing a user to user transaction involving controlled payment numbers in accordance with exemplary embodiments.

FIG. 6 is a flow diagram illustrating the processing of transactions using the processing server of FIG. 2 in accordance with exemplary embodiments.

FIG. 7 is a flow chart illustrating an exemplary method for providing credit for a user account in accordance with exemplary embodiments.

FIG. 8 is a flow chart illustrating an exemplary method for processing transactions in user accounts in accordance with exemplary embodiments.

FIG. 9 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require and special knowledge in offered products. In some embodiments, an entity involved in a single transaction may be considered a merchant.

Controlled Payment Number—Controlled payment numbers may be payment numbers associated with a payment account that are subject to one or more rules. In many cases, these rules may be set by a cardholder, such as spending limits, limits on days and/or times of a transaction, limits on merchants or industries, transaction spending or frequency limits, etc. Controlled payment numbers may offer an account holder an opportunity to give payment cards tied to the account to others for use, but subject to rules set by the cardholder, such as an employer distributing cards to employees, or a parent distributing cards to children. Additional detail regarding controlled payment numbers may be found in U.S. Pat. No. 6,636,833, issued Oct. 21, 2003; U.S. Pat. No. 7,136,835, issued Nov. 14, 2006; U.S. Pat. No. 7,571,142, issued Aug. 4, 2009; U.S. Pat. No. 7,567,934, issued Jul. 28, 2009; U.S. Pat. No. 7,593,896, issued Sep. 22, 2009; U.S. patent application Ser. No. 12/219,952, filed Jul. 30, 2008; U.S. patent application Ser. No. 12/268,063, filed Nov. 10, 2008; and U.S. patent application Ser. No. 12/359,971, filed Jan. 26, 2009; each of which is herein incorporated by reference in its entirety.

System for Processing Transactions with User Accounts

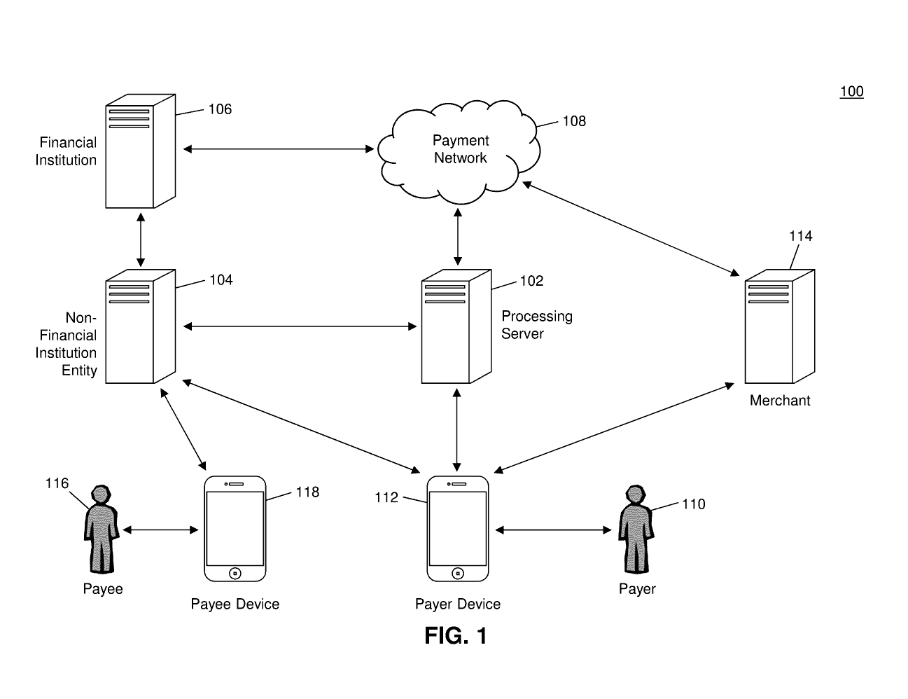

FIG. 1 illustrates a system 100 for the crediting of user accounts and use thereof in user-to-merchant and user-to-user payment transactions via the use of controlled payment numbers for users of a non-financial institution entity.

The system 100 may include a processing server 102. The processing server 102, discussed in more detail below, may be configured to credit user accounts, assist in the processing of transactions involving user accounts, manage user accounts, and otherwise provide for assistance with associations between user accounts and controlled payment numbers for users of a non-financial institution (NFI) entity 104 using the methods discussed herein. The NFI entity 104 may be, for example, a social network, a gaming platform, an entertainment website, a news service, or any other entity that may not be a financial institution, but may have users that may benefit from being involved in payment transactions.

The NFI entity 104 may have a transaction account established with a financial institution 106. The financial institution 106 may be, for instance, an issuing bank, or other suitable type of financial institution configured to establish and operate transaction accounts. The transaction account associated with the NFI entity 104 may be used by the NFI entity 104 to conduct payment transactions using traditional methods and systems. Payment transactions involving the NFI entity 104 may be conducted via a payment network 108 using traditional methods and systems.

The financial institution 106, payment network 108, and/or processing server 102 may be configured to provide the NFI entity 104 with controlled payment number (CPNs) associated with their transaction account. CPNs may be subject to one or more limits set forth by the NFI entity 104 and/or financial institution 106, but, when used, may draw on the associated transaction account. Each CPN may have a different number that may be different from the primary account number associated with the transaction account that, when used in a transaction, may trigger the checking of the transaction against limits set on the CPN. For instance, a CPN may be established that has a spending limit of $50 per transaction. When the CPN is used in a transaction, the payment network 108 may identify that a CPN is used, identify its associated limits, and may evaluate limits as applied to the transaction. If the transaction is within the $50 limit, it may be processed, with payment being drawn from the associated transaction account. If the transaction exceeds the $50 limit, it may be declined, and the NFI entity 104 and/or financial institution 106 may be identified.

The processing server 102 may be configured to provide the NFI entity 104 with CPNs for users of the NFI entity 104. The processing server 102 may be configured to communicate with the payment network 108 and/or financial institution 106 to request issuance of new CPNs and to adjust spending limits on CPNs using methods and systems that will be apparent to persons having skill in the relevant art. In some instances, the processing server 102 may be a part of the payment network 108 or financial institution 106 and may manage CPNs through internal communications as applicable. In some cases, the processing server 102 may be a part of the NFI entity 104.

In the system 100, a payer 110 may be a user of the NFI entity 104. The payer 110 may communicate with the NFI entity 104 via a payer device 112. The payer device 112 may be any suitable type of computing device, such as a desktop computer, laptop computer, notebook computer, tablet computer, cellular phone, smart phone, smart watch, smart television, wearable computing device, implantable computing device, etc. The payer 110 may use the payer device 112 to register as a user of the NFI entity 104, such as by signing up for services offered by the NFI entity 104 via a webpage, application program, etc. For example, if the NFI entity 104 is a social network, the payer 110 may use an application program associated with the social network on the payer device 112 to register as a user of the social network and access the services provided thereby.

As one of the services, the NFI entity 104 may provide the payer 110 with the ability to conduct payment transactions using their user account. In order to conduct payment transactions, the payer 110 may first be required to buy currency to be associated with their user account. Using the payer device 112, the payer 110 may initiate a payment transaction for the purchase of currency from the NFI entity 104. Details for the payment transaction may be provided to the processing server 102. The processing server 102 may identify that the transaction is for the purchase of currency based on data included in the transaction details. For example, the transaction details may include an indication that the transaction is for the purchase of currency, such as a data value indicative of the type of transaction, or the inclusion of the account number associated with the NFI entity's transaction account, which may be used only in the purchase of currency, for example.

The processing server 102 may identify a user account associated with the payer 110. In some instances, the payer 110 may provide their account information, such as an account identifier, as part of the transaction process. In other instances, the NFI entity 104 may provide the payer's account information during the submission of the transaction data, such as included in a data element of a transaction message or in a separate, accompanying message. The processing server 102 may identify a CPN associated with the user account of the payer 110. If the payer 110 is not already associated with a CPN, the processing server 102 may request a CPN be issued by the payment network 108 or financial institution 106 as applicable. The CPN may be issued with a spending limit corresponding to the amount of currency being purchased by the payer 110. In instances where the payer 110 already has a CPN associated thereto, the processing server 102 may request that the spending limit of the CPN be increased based on the amount of currency being purchased. The result is that the payer 110 may have a CPN that is associated with the NFI entity's transaction account that has a spending limit commiserate with the amount of currency purchased by the payer 110.

The spending limit of CPNs associated with users may represent currency available for spending by users of the NFI entity 104. In some instances, the actual spending limit may be represented to users directly. For example, if a user is associated with a CPN with a spending limit of $100, the user's account may reflect a balance of $100. In other instances, an alternative currency may be used, such as a different fiat currency, a virtual, non-fiat currency, a cryptocurrency, etc. For example, the NFI entity 104 may have a transaction account that is established in U.S. dollars, and thus a user may have a spending limit of $100, but may be represented to the user as the equivalent amount in a different currency, such as one local to the user, such as in Euros. In another example, the NFI entity 104 may establish a currency unique to the NFI entity, such as “credits,” and may represent a user's spending limit in an equivalent amount of credits based on their spending limit. For instance, if the NFI entity 104 establishes that 100 credits is equivalent to $1, a user with a $100 spending limit may have their account reflect a balance of 10,000 credits.

Users of the NFI entity 104 may be able to use their user account in conducting payment transactions with third parties, such as an outside merchant 114. The payer 110 may initiate a payment transaction with a merchant 114 for the purchase of goods or services and may present their CPN associated with their user account for payment. In some instances, the transaction may be an e-commerce transaction, with the CPN provided to the merchant 114 electronically. In other instances, the payer 110 may be issued a physical card encoded with payment credentials associated with the CPN, which may be presented to the merchant 114 similar to a traditional payment card. The merchant 114 may then process the payment transaction using the CPN. A transaction message may be submitted to the payment network 108 that includes the CPN as the primary account number used to fund the transaction. The payment network 108 may then process the transaction using traditional methods and systems for processing of transactions involving CPNs.

The processing server 102 may adjust the spending limit of the payer's CPN as a result of the transaction with the merchant 114. For example, if the payer 110 spends $50 at the merchant 114, the processing server 102 may request the financial institution 106 or payment network 108 to reduce the spending limit of the CPN by $50. The resulting spending limit may be reflected in the user's account when accessing the NFI entity 104, showing their reduced balance. Thus, users of the NFI entity 104 may be able to conduct payment transactions with outside merchants 114 using their user account, without requiring the NFI entity 104 to operate as a financial institution, and without the NFI entity 104 possessing or obtaining any payment information from users. Instead, CPNs are issued on the transaction account of the NFI entity 104, with their spending limit indicated to the user as being an available balance.

User CPNs may also be advantageous for use in the conducting of user-to-user transactions for users of the NFI entity 104. The payer 110 may conduct a payment transaction to make a payment to the payee 116 with the payee 116 using a payee device 118. Like the payer device 112, the payee device 118 may be any suitable type of computing device, such as a desktop computer, laptop computer, notebook computer, tablet computer, cellular phone, smart phone, smart watch, smart television, wearable computing device, implantable computing device, etc. Traditionally, a person-to-person payment transaction may require the submission of a transaction message to the payment network 108 that includes payment credentials for a transaction account associated with each of the payer 110 and the payee 116. Such transaction processing often involves specific technical hardware configured to generate transaction messages, which are often specially formatted, and to communicate with payment networks 108, which involves specialized communication paths and protocols. However, many payers 110, payees 116, and NFI entities 104 may lack the technical hardware able to perform such processes.

Using the system 100, in order to make a payment from the payee 110 to the payer 116, the payee 110 may use their user account via the payer device 112 to initiate a transaction for the payment of currency to the payee 116 via the NFI entity 104. The NFI entity 104 may receive the transaction request and may forward the transaction request to the processing server 102. The processing server 102 may submit a request to the financial institution 106 or payment network 108 as applicable to increase the spending limit for the CPN associated with the payee 116 by the transaction amount, and decrease the spending limit for the CPN associated with the payer 110 by the transaction amount.

As a result, the payer 110 and payee 116 may participate in a user-to-user transaction where the available spending for each of the users has been adjusted accordingly, but without requiring the processing of a payment transaction using the payment network 108. By using CPNs and adjusting their spending limits to represent a transaction, the NFI entity 104 may provide for user-to-user payments without requiring the NFI entity 104 or user devices to be modified to generate transaction message or configured to use specialized communication protocols to perform communications with the payment network 108. Thus, the processing server 102 may provide for significant technical advantages over traditional systems by enabling the NFI entity 104 to provide users with user-to-user payment transactions without requiring processing by traditional payment networks 108, while still enabling users to conduct payment transactions with outside merchants 114 using the same accounts.

### Processing Server

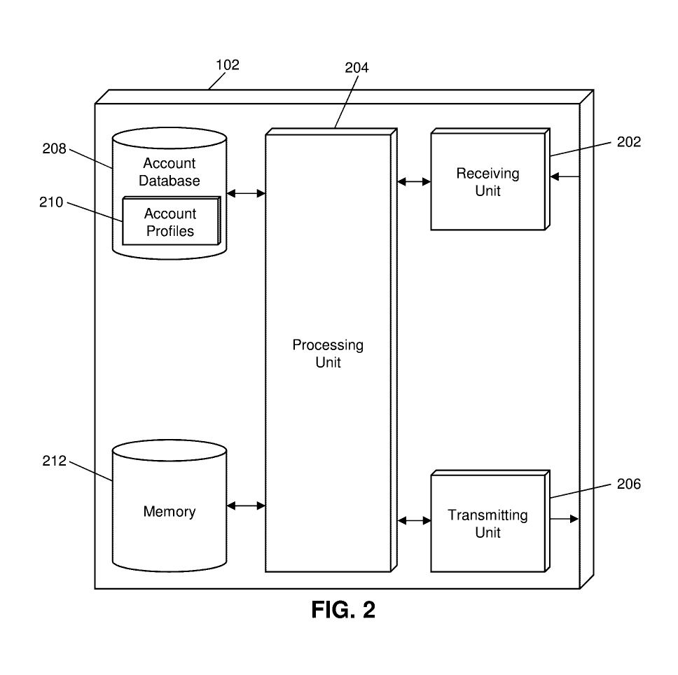

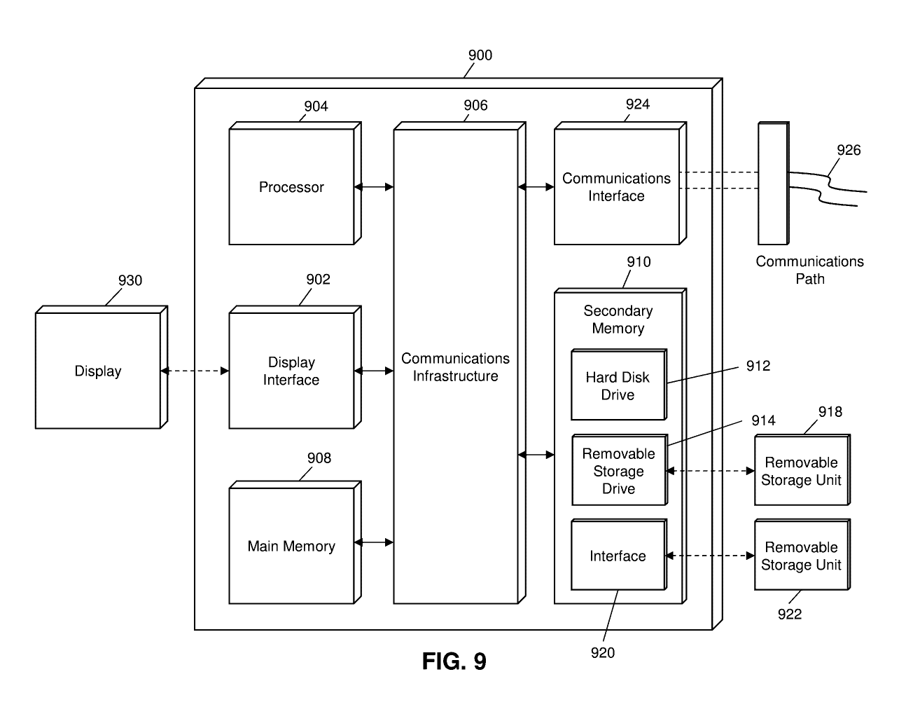

FIG. 2 illustrates an embodiment of the processing server 102 of the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 900 illustrated in FIG. 9 and discussed in more detail below may be a suitable configuration of the processing server 102.

The processing server 102 may include a receiving unit 202. The receiving unit 202 may be configured to receive data over one or more networks via one or more network protocols. The receiving unit 202 may receive data communications from the NFI entity 104, payer device 112, payee device 118, etc., which may utilize the Internet, local area networks, or other suitable networks and associated protocols. The receiving unit 202 may also be configured to receive transaction messages. Transaction messages may be formatted pursuant to one or more standards, such as the International Organization for Standardization's ISO 8583 standard, and may include a plurality of data elements. Each data element in the transaction message may be configured to store data based on the associated standards. In some instances, transaction messages may also include additional data, such as message type indicators.

The processing server 102 may also include an account database 208. The account database 208 may be configured to store a plurality of account profiles 210. Each account profile 210 may be configured to store data related to a user account associated with the NFI entity 104. Each account profile 210 may include at least a CPN associated with the related user account and a spending limit for the CPN. The spending limit may be represented in the currency of the transaction account associated with the CPN, or may be represented in a different currency as established by the NFI entity 104. The spending limit may be such that transactions conducted involving the CPN may be subject to the spending limit, or an equivalent amount in a related fiat currency, and may not be conducted if the transaction amount exceeds the spending limit. The spending limit may be adjusted as a result of payment transactions, including user-to-merchant transactions, user-to-user transactions, and transactions involving the purchase of additional currency by the related user.

The processing server 102 may further include a processing unit 204. The processing unit 204 may be configured to perform the functions of the processing server 102 as discussed herein as will be apparent to persons having skill in the relevant art. The processing unit 204 may be configured to process transactions involving users of the NFI entity 104 based on transaction messages and transaction requests received by the receiving unit 202.

For example, if the receiving unit 202 receives a transaction message for the purchase of currency by a user, the processing unit 204 may be configured to initiate a payment transaction for payment from the user to the NFI entity's transaction account and for the increase and/or establishment of a spending limit for a CPN associated with the user based on the transaction amount. The transaction message may be forwarded to the payment network 108 for processing of payment from the user. In some instances, the processing unit 204 may generate a new transaction message for submission to the payment network 108 for payment from the user to the NFI entity 104.

The processing unit 204 may also generate a request to submit to the financial institution 106 or payment network 108 as applicable (e.g., depending on which entity may control usage of the CPN) to increase the spending limit of a CPN associated with the user. The CPN may be identified in the transaction message, or may be identified in a separate message provided by the user or the NFI entity 104. In some instances, an account identifier associated with the user account may be provided, which may be used by the processing unit 204 to identify an account profile 210 stored in the account database 208, which may be used to identify the CPN for which the spending limit is to be increased. In instances where a user may purchase currency without having a previously established CPN, the processing unit 204 may generate a request for issuance of a CPN for use by the user, with the spending limit being based on the transaction amount. In some cases, the spending limit may be adjusted by an amount different from the transaction amount, such as due to processing fees.

The processing unit 204 may be configured to identify such a transaction via data included in the received transaction message. For instance, a data element in the transaction message may be configured to store an indication that the transaction is for the purchase of currency. In another instance, if the payee account number included in a corresponding data element in the transaction message is an account number associated with the transaction account of the NFI entity 104 for which CPNs are to be associated, then the transaction may be indicative of one for the purchase of currency by a user.

In another example, the receiving unit 202 may receive a transaction message from a merchant 114 for a user-to-merchant transaction. In some instances, the receiving unit 202 may receive a copy of a transaction message used in a user-to-merchant transaction from the payment network 108. In yet another instance, the financial institution 106 and/or NFI entity 104 may provide the processing server 102 with data associated with a user-to-merchant transaction (e.g., which was drawn on the transaction account of the NFI entity 104 via a CPN). The processing unit 204 may be configured to submit a request to the financial institution 106 or payment network 108 as applicable to decrease the spending limit associated with the CPN used in the payment transaction.

In yet another example, the receiving unit 202 may receive a transaction request from a payer device 112, payee device 118, and/or NFI entity 104 for a user-to-user transaction. The processing unit 204 may generate a request for submission to the applicable entity to decrease the spending limit of the CPN associated with the payer 110 by the transaction amount, and a request for submission to increase the spending limit of the CPN associated with the payee 116 by the transaction amount.

The processing unit 204 may also be configured to perform any additional functions of the processing server 102 suitable for performing the methods and systems discussed herein. For example, the processing unit 204 may be configured to perform currency conversions, generate account alerts, generate notifications, etc.

The processing server 102 may also include a transmitting unit 206. The transmitting unit 206 may be configured to transmit data over one or more networks via one or more network protocols. The transmitting unit 206 may be configured to transmit transaction messages to the payment network 108 using associated communication protocols, may be configured to transmit data requests to the financial institution 106 and/or payment network 108 requesting issuance of CPNs and adjustments of spending limits for CPNs, may be configured to transmit notifications to the NFI entity 104 regarding transactions and CPN adjustments, may be configured to transmit notifications to payer devices 112 and payee devices 118 regarding transactions, etc.

The processing server 102 may further include a memory 212. The memory 212 may be configured to store data for the processing server 102 suitable for performing the functions disclosed herein. For example, the memory 212 may be configured to store data formatting rules and algorithms (e.g., associated with transaction messages standards), communication protocol data, currency exchange rates and algorithms, etc. Additional data that may be stored in the memory 212 will be apparent to persons having skill in the relevant art.

### Process for Crediting a User Account

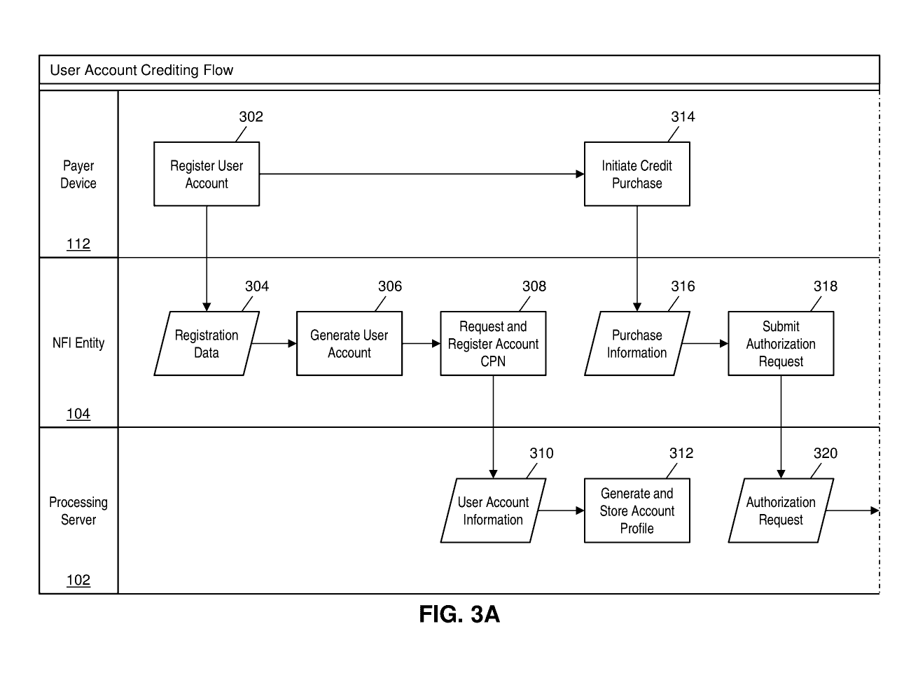

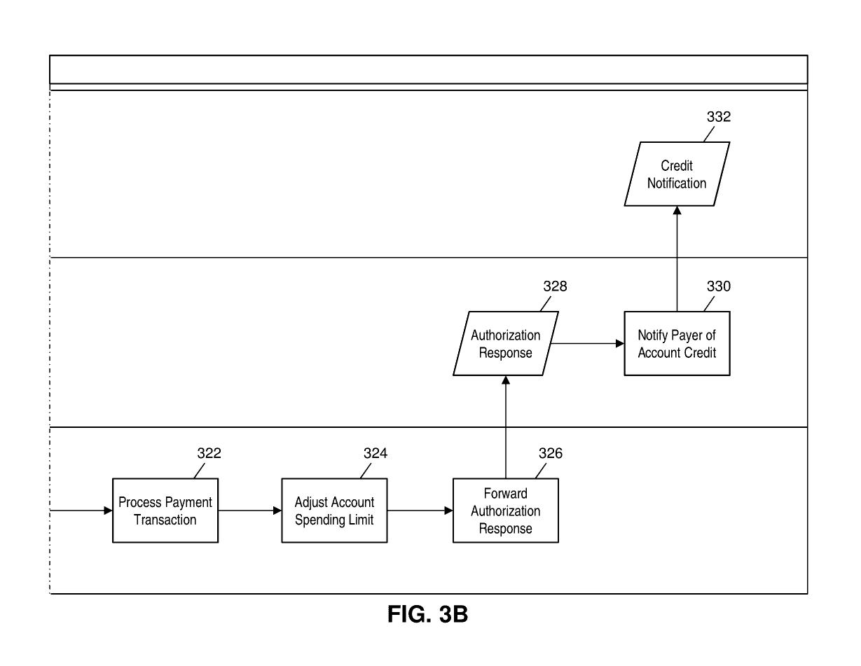

FIGS. 3A and 3B illustrate a process for the crediting of a user account via increase of a spending limit of a CPN associated with the user account with the NFI entity 104.

In step 302, the payer 110 may utilize the payer device 112 to register a user account with the NFI entity 104. As part of the registration, registration data may be submitted by the user to the NFI entity 104, which may receive the data in step 304. The registration data may include a username, password, e-mail address, and any other data that may be suitable dependent on the NFI entity 104 and the services provided to the payer 110. In step 306, the NFI entity 104 may generate a user account, which may include the storage of user registration data in an internal or external database.

In step 308, the NFI entity 104 may request a CPN from the financial institution 106 or payment network 108 (not shown), as applicable, and register the CPN as being associated with the new user account. In step 310, the NFI entity 104 may transmit account information associated with the user account to the processing server 102, which may be received by the receiving unit 202. The account information may include at least the CPN associated with the account, and may also include any other data that may be suitable for performing the functions disclosed here, such as a user identifier (e.g., username, e-mail address, user identification number, etc.). In some embodiments, the CPN may be requested by the processing server 102. In such an embodiment, the processing server 102 may request the CPN following receipt of the user account information, and may provide the CPN to the NFI entity 104 for registration.

In step 312, the processing unit 204 of the processing server 102 may generate an account profile 210 to be associated with the new user account and store the account profile 210 in the account database 208. The account profile 210 may include at least the CPN and a spending limit associated thereto. In some instances, the CPN, as initially requested, may have a zero spending limit.

In step 314, the payer 110 may initiate a purchase to credit their user account via the payer device 112. The purchase may be initiated via use of the platform provided by the NFI entity 104 (e.g., such as a social network) and may be for the purchase of a specified amount of currency. In step 316, the NFI entity 104 may receive purchase information submitted by the payer 110 via the payer device 112 in the initiation of the transaction, which may include at least the currency amount to be purchased and payment credentials for funding of the payment transaction. In step 318, the NFI entity 104 may submit to the processing server 102 an authorization request for the payment transaction from the payer 110 to the NFI entity 114. In some embodiments, the authorization request may be submitted by a third party, such as the financial institution 106 or other third party configured to process transactions on behalf of the NFI entity 104. In such instances, the purchase information submitted by the payer 110 in step 316 may be submitted to the third party, such that the NFI entity 104 may not possess or come into contact with payer payment credentials.

In step 320, the receiving unit 202 of the processing server 102 may receive the authorization request. The authorization request may be a transaction messages formatted pursuant to one or more standards and include a plurality of data elements. The data elements may include at least a data element configured to store a primary account number and a data element configured to store a transaction amount. In some embodiments, the authorization request may also include a data element configured to store a user identifier or CPN, which may be provided by the payer 110 or the NFI entity 104. In some instances, the CPN may be included as a payee of the transaction, such that payment may be made to the transaction account associated with the NFI entity 104 via the association of the CPN with the transaction account.

In step 322, the processing unit 204 of the processing server 102 may process the payment transaction. Processing of the payment transaction may include forwarding, by the transmitting unit 206 of the processing server 102, the transaction message to a payment network 108. In some embodiments, the processing unit 204 may be required to generate a transaction message to forward to the payment network 108, such as in instances where the data may come to the processing server 102 in a format not suitable for transmission to the payment network 108.

In step 324, the transmitting unit 206 may transmit a request to the financial institution 106 or payment network 108, as applicable, to increase the spending limit of the CPN based on the transaction amount. In some instances, the spending limit may be increased based on the transaction amount on a 1:1 basis. In other instances, the spending limit may be increased by an amount less than the transaction amount, and/or may be increased by an amount of a different currency based on a currency exchange rate. In embodiments where the authorization request may not include the CPN, step 324 may also include identification of an account profile 210 associated with the user involved in the transaction for identification of the CPN to be included in the request to increase the spending limit. In such embodiments, the transaction message may include a user identifier or other suitable value, which may be included in a query ran on the account database 208 by the processing unit 204 to identify the account profile 210 associated with the user involved in the transaction.

In step 326, the receiving unit 202 of the processing server 102 may receive an authorization response from the payment network 108 for the payment transaction, and the transmitting unit 206 of the processing server 102 may forward the authorization response on to the NFI entity 104 (e.g., or other third party acting on behalf of the NFI entity 104). In step 328, the NFI entity 104 may receive the authorization response, which may indicate successful or unsuccessful processing of the payment transaction.

In step 330, the NFI entity 104 may transmit a notification to the payer 110 via the payer device 112 indicating the balance of their account following receipt of the authorization response. For example, if the authorization response indicates that the transaction was successful, then the spending limit for the CPN will have been increased. In some embodiments, the processing server 102 may provide an additional message (e.g., separate from and/or accompanying the authorization response) indicative of the increasing of the spending limit of the CPN. In step 332, the payer device 112 may receive the notification of account credit, which may be displayed to the payer 110 to notify the payer 110 of their current amount of currency available for use via their user account.

### Process for User-to-Merchant Transactions

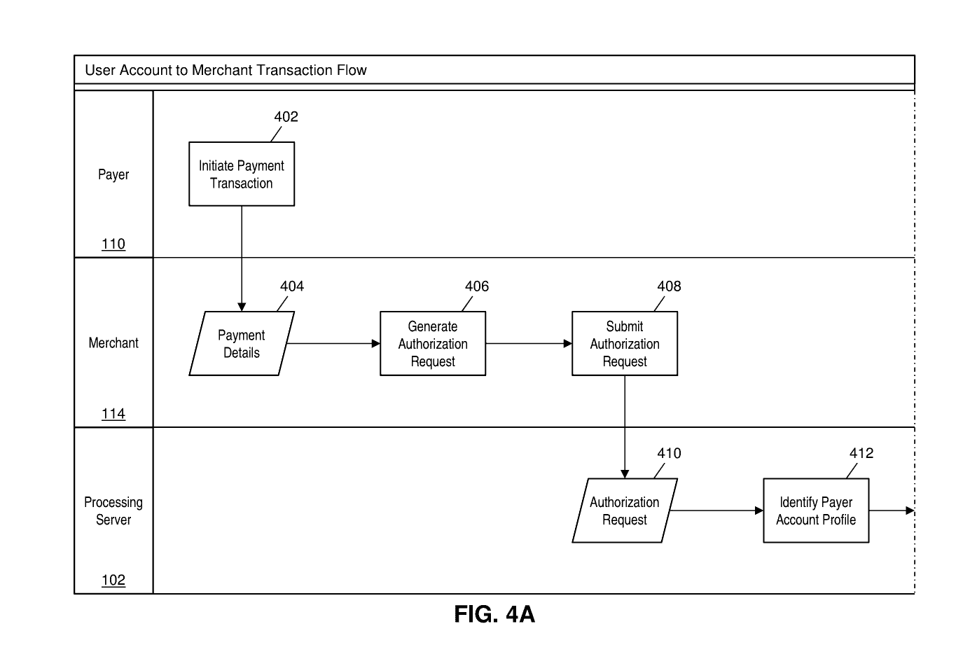

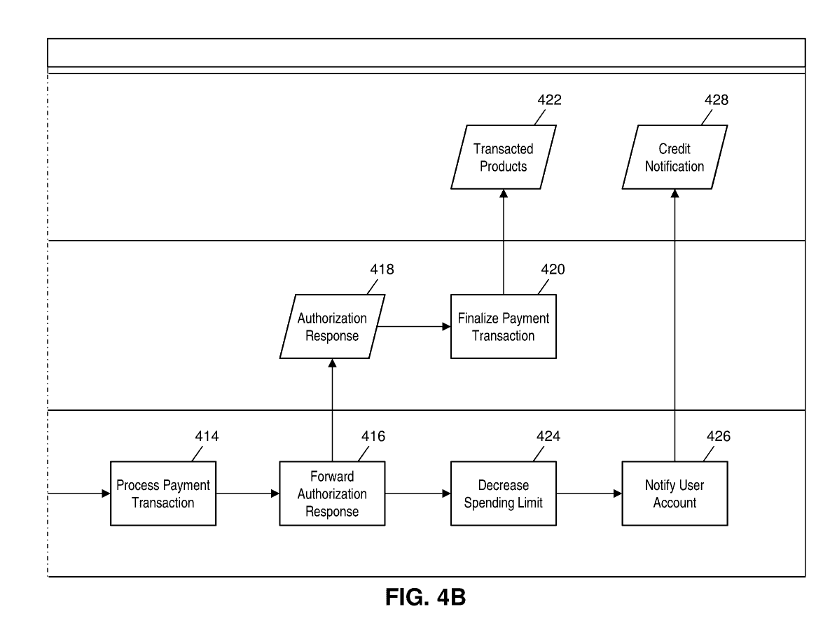

FIGS. 4A and 4B illustrate a process for a user-to-merchant transaction involving a user account with the NFI entity 104 and an external merchant 114 via the CPN associated with the user account.

In step 402, the payer 110 may initiate a payment transaction with a merchant 114 using their payer device 112, which may include the transmission of payment credentials associated with the CPN to the merchant 114. In some embodiments, the payment transaction may be an in-person transaction, which may be initiated by the payer 110 providing payment credentials associated with the CPN to the merchant 114 at a point of sale, such as via a physical card encoded with payment credentials associated with the CPN or via the payer device (e.g., using near field communication). In step 404, the merchant 114 may receive the payment credentials, which may include at least the CPN associated with the user account.

In step 406, the merchant 114 (e.g., or a third party entity acting on behalf of the merchant, such as a financial institution, such as an acquiring bank, the financial institution 106, etc.) may generate an authorization request for the payment transaction. The authorization request may be a transaction message formatted pursuant to one or more standards, which may include a message type indicator indicative of an authorization request, and may include a plurality of data elements including at least a data element configured to store a primary account number that includes the CPN and a data element configured to store a transaction amount. In step 408, the merchant 114 (or a third party entity) may submit the authorization request to the processing server 102.

In step 410, the receiving unit 202 of the processing server 102 may receive the authorization request. In step 412, the processing unit 204 of the processing server 102 may identify the account profile 210 associated with the payer 110 involved in the transaction. The account profile 210 may be identified via querying of the account database 208 using the CPN stored in the data element of the authorization request configured to store a primary account number. In step 414, the payment transaction may be processed, which may be performed via the forwarding of the authorization request to the payment network 108 by the transmitting unit 206 of the processing server 102. In step 416, an authorization response may be received from the payment network 108 and may be forwarded on to the merchant 114. In step 418, the merchant 114 may receive the authorization response. In some embodiments, the authorization request may be initially submitted to the payment network 108, which may forward the authorization request, a copy thereof, and/or transaction data included therein to the processing server 102, which may be received by the processing server 102 in step 410. In such embodiments, the authorization response and/or an indication included therein may be forwarded to both the merchant 114 and the processing server 102 by the payment network 108.

In step 420, the merchant 114 may finalize the payment transaction based on the received authorization response. For example, if the authorization response indicates that the transaction was approved, the merchant 114 may provide the payer 110 with the transacted-for goods or services, which may be received by the payer 110 in step 422. If the authorization response indicates that the transaction was denied, the merchant 114 may inform the payer 110 and may withhold providing any goods or services to the payer 110.

In step 424, the processing unit 204 of the processing server 102 may generate a request, which may be submitted to the financial institution 106 or payment network 108, as applicable, requesting decrease of the spending limit associated with the CPN used in the payment transaction. The request may include at least the CPN and the transaction amount for the payment transaction. The spending limit for the CPN may be adjusted accordingly, and, in step 426, the transmitting unit 206 may transmit a notification to the payer 110, via the payer device 112. In some embodiments, the notification may be transmitted to the NFI entity 104, which may, in turn, transmit a notification to the payer 110, via the payer device 112. In step 428, the payer device 112 may receive the notification and display it to the payer 110, which may notify the payer of the credit (e.g., currency amount) still available for use via their user account, which may correspond to the spending limit still available with the associated CPN.

### Process for User-to-User Transactions

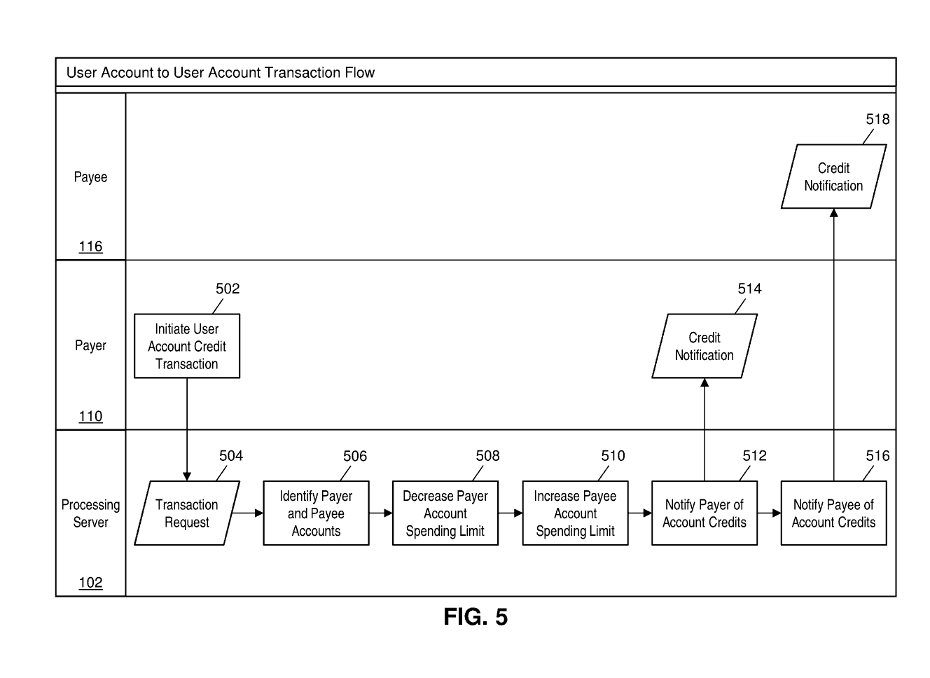

FIG. 5 illustrates a process for a user-to-user transaction involving user accounts with the NFI entity 104 via the use of CPNs such that funds may be transferred without the use of the payment network 108.

In step 502, the payer 110 may, via the payer device 112, initiate a transaction for payment of credits (e.g., or other currency associated with the NFI entity 104) to the payee 116. The transaction may be initiated using the payer device 112 via a website, application program, or other suitable method provided by the NFI entity 104 or on behalf of the NFI entity 104. In step 504, the receiving unit 202 of the processing server 102 may receive a transaction request for the transaction. The transaction request may include at least the CPN associated with the payer 110, the CPN associated with the payee 116, and the transaction amount. In some embodiments, the transaction request may be a transaction message formatted pursuant to one or more applicable standards, with the included data being comprised in one or more data elements.

In step 506, the processing unit 204 of the processing server 102 may identify a payer account profile 210 in the account database 208 and a payee account profile 210 in the account database 208. The account profiles 210 may be identified by inclusion of the CPNs included in the received transaction request. In step 508, the processing unit 204 may decrease the account spending limit for the payer account profile 210, which may be accomplished by transmitting, via the transmitting unit 206, an instruction to the financial institution 106 or payment network 108, as applicable, to decrease the spending limit of the corresponding CPN. In step 510, the processing unit 204 may increase the account spending limit for the payee account profile 210, such as by transmitting, via the transmitting unit 206, a corresponding instruction to the relevant entity.

In step 512, the transmitting unit 206 may transmit a notification to the payer 110 via the payer device 112, to inform the payer 110 of the remaining credits (e.g., available spending limit) in the user account. In step 514, the payer 110 may receive the notification via the payer device 112, which may be displayed to the payer 110 using known methods. In step 516, the transmitting unit 206 of the processing server 102 may transmit a notification to the payee 116, via the payer device 118, to inform the payee 116 of their available credits in their user account. In step 518, the payee 116 may receive the notification via the payee device 118, which may be displayed to the payee 116 using known methods.

### Processing of User Account Transactions

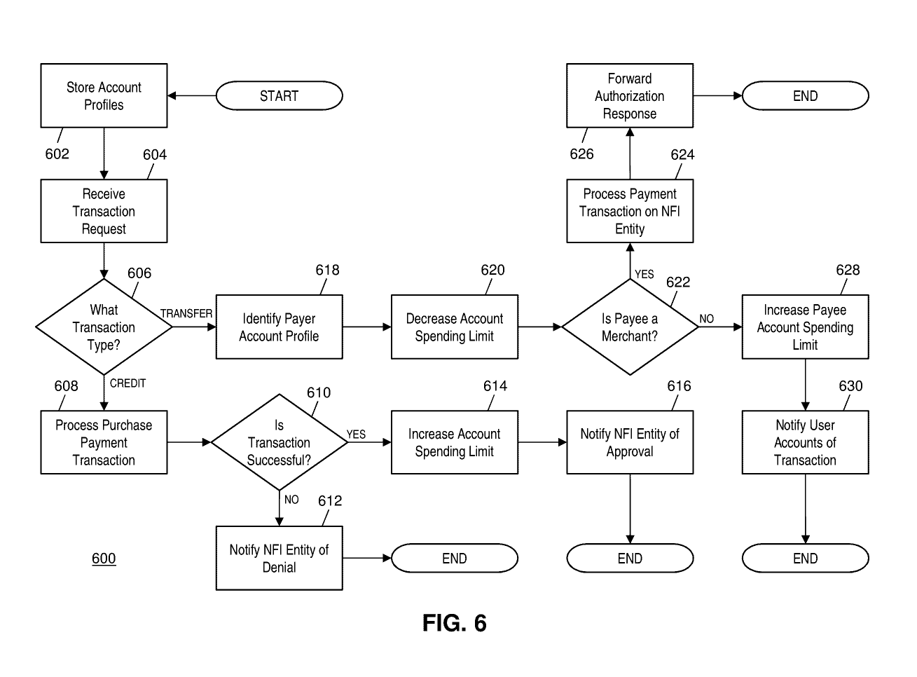

FIG. 6 illustrates a process 600 for the processing of transactions involving user accounts with the NFI entity 104 by the processing server 102 via the use of CPNs.

In step 602, the processing server 102 may store a plurality of account profiles 210 in the account database 208. Each account profile 210 may include at least a CPN and a spending limit, and may also include additional account information associated with a related user account with the NFI entity 104, such as a user identifier. In step 604, the receiving unit 202 of the processing server 102 may receive a transaction request. The transaction request may be a transaction message formatted pursuant to one or more standards, or may be another suitable type of data message. In step 606, the processing unit 204 of the processing server 102 may determine what type of transaction the received transaction request is for.

The determination may be based on the type of transaction request received, data stored in the transaction request, one or more entities involved in the request, etc. For instance, if the transaction request includes a user identifier and a transaction account and/or the transaction account corresponds to the transaction account associated with the NFI entity 104, the transaction may be a credit transaction. If the transaction is a credit transaction, then, in step 608, the processing unit 204 may process the payment transaction for the purchase of currency with the NFI entity 104. Processing of the payment transaction may include forwarding an authorization request to the payment network 108 for processing.

In step 610, the processing unit 204 may determine if the transaction was successful. The determination may be made based on an authorization response received from the payment network 108 and a response code or other data included therein, which may be stored in one or more data elements of the authorization response as based on associated standards. If the transaction is unsuccessful, then, in step 612, the transmitting unit 206 of the processing server 102 may transmit a notification to the NFI entity 104 and/or user involved in the transaction that the transaction was unsuccessful. In some instances, the notification may include a reason, which may be included in the received authorization response.

If the transaction is successful, then, in step 614, the processing unit 204 may increase the spending limit associated with the user account involved in the transaction. This may include the identification of a corresponding account profile 210 using the CPN and/or user identifier included in the received authorization request, and then submitting (e.g., via the transmitting unit 206) a request to the financial institution 106 or payment network 108, as applicable, to increase the spending limit for the CPN. In step 616, the transmitting unit 206 may transmit a notification to the NFI entity 104 and/or user (e.g., via a corresponding user device) indicating that the transaction was approved, and that the spending limit has been increased.

If, in step 606, it is determined that the transaction is for the transfer of funds from the user to another party, then, in step 618, the processing unit 204 may identify an account profile 210 stored in the account database 208 associated with a payer 110 involved in the transaction. The account profile 210 may be identified via a CPN included in a data element of the received transaction message configured to store a personal account number. In step 620, the spending limit for the CPN included in the identified account profile 210 may be decreased. The spending limit may be decreased via the transmission of a request by the transmitting unit 206 to the financial institution 106 or payment network 108, as applicable, for reduction in the spending limit by a transaction amount included in the transaction request, such as included in a data element configured to store a transaction amount in the transaction message.

In step 622, the processing unit 204 may determine if the payee for the transaction is another user (e.g., the payee 116) or a merchant 114. The payee may be determined based on the recipient included in the received transaction request, and/or the type of request. For example, if the transaction request is not a message, and/or the recipient is a CPN or user identifier, then the payee may be determined to be another user of the NFI entity 104. If the payee is determined to be a merchant 114, then, in step 624, the processing unit 204 may process a payment transaction for payment to the merchant 114. The payment transaction may be drawn on the transaction account of the NFI entity 104, as a result of use of the CPN associated with the payer 110, which may be tied to the NFI entity's transaction account. In step 626, an authorization response may be received by the receiving unit 202 from the payment network 108 due to processing of the payment transaction, which may be forwarded on to the merchant 114, an acquiring bank, the NFI entity 104, and/or to the payer 110 via the payer device 112 by the transmitting unit 206.

If, in step 622, the processing unit 204 determines that the payee is not a merchant 114 but another user of the NFI entity 104, then, in step 628, the processing unit 204 may identify an account profile 210 in the account database 208 associated with the payee 116 based on inclusion of a CPN included as the recipient in the received transaction request, and may submit a request to the financial institution 106 or payment network 108, as applicable, to increase the spending limit of the CPN. In step 630, the transmitting unit 206 may transmit a notification to the payer 110 and payee 116 to notify the respective users of the adjustments to their spending limit based on the transaction. In some instances, the processing server 112 may notify the NFI entity 104, which may notify the users of the transaction and resulting account balances.

### Exemplary Method for Providing Credit for a User Account

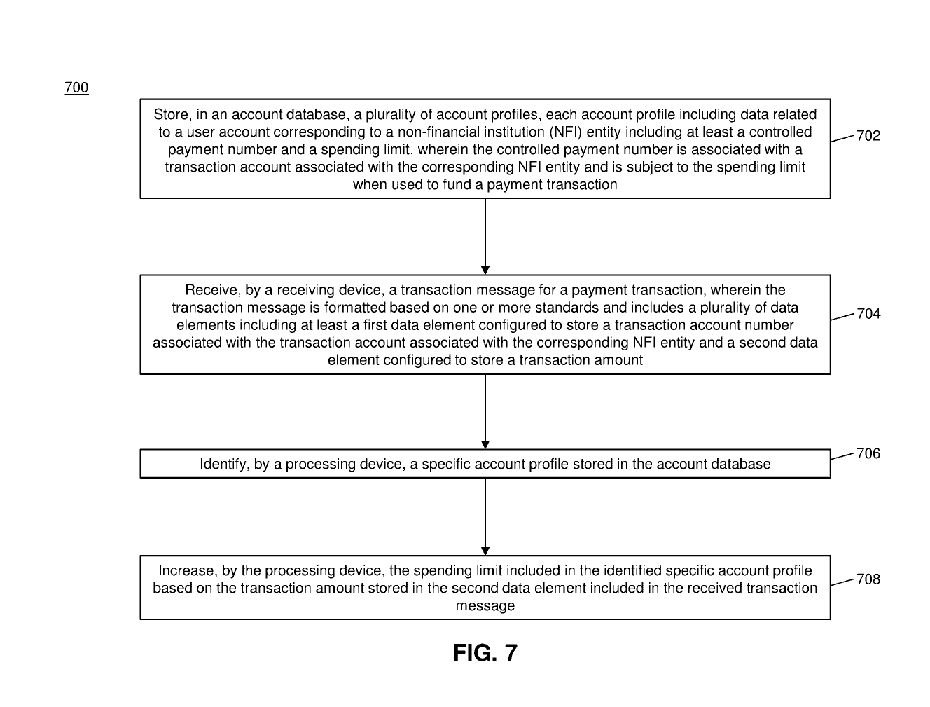

FIG. 7 illustrates a method 700 for the providing of credit to a user account with an NFI entity 104 via the spending limit of a CPN.

In step 702, a plurality of account profiles (e.g., account profiles 210) may be stored in an account database (e.g., the account database 208), wherein each account profile 210 includes data related to a user account corresponding to a non-financial institution (NFI) entity (e.g., the NFI entity 104) including at least a controlled payment number (CPN) and a spending limit, wherein the CPN is associated with a transaction account associated with the corresponding NFI entity 104 and is subject to the spending limit when used to fund a payment transaction. In some embodiments, payment transactions involving a CPN included in a stored account profile 210 may be drawn against the associated transaction account.

In step 704, a transaction message for a payment transaction may be received by a receiving device (e.g., the receiving unit 202), wherein the transaction message is formatted based on one or more standards and includes a plurality of data elements including at least a first data element configured to store a transaction account number associated with the transaction account associated with the corresponding NFI entity 104 and a second data element configured to store a transaction amount. In one embodiment, the transaction message may further include a message type indicator indicative of an authorization request.

In step 706, a specific account profile 210 stored in the account database 208 may be identified by a processing device (e.g., the processing unit 204). In one embodiment, the transaction message may further include a third data element configured to store a CPN, and the specific account profile 210 may be identified based on inclusion of a CPN that corresponds to the CPN stored in the third data element included in the received transaction message. In step 708, the spending limit included in the identified specific account profile 210 may be increased by the processing device 204 based on the transaction amount stored in the second data element included in the received transaction message.

In one embodiment, the transaction message may further include a third data element configured to store a transaction account number associated with a payer (e.g., the payer 110), and the method 700 may further include processing, by the processing device 204, the payment transaction for payment of the transaction amount from a transaction account associated with the transaction account number associated with the payer 110 to the transaction account associated with the corresponding NFI entity 104. In a further embodiment, the method 700 may even further include transmitting, by a transmitting device (e.g., the transmitting unit 206), a response message formatted based on the one or more payment network standards in response to the received transaction messaged based on a result of the processing of the payment transaction.

In some embodiments, the method 700 may also include receiving, by the receiving device 202, an account adjustment request from an NFI entity 104, wherein the account adjustment request includes at least a specific CPN associated with a transaction account associated with the NFI entity, and wherein the specific account profile 210 is identified based on inclusion of the specific CPN included in the received account adjustment request. In a further embodiment, the account adjustment request may further include an adjustment amount based on the transaction amount stored in the second data element included in the received transaction message, and the spending limit included in the identified specific account profile 210 may be increased by the adjustment amount included in the received account adjustment request. In an even further embodiment, the adjustment amount and the spending limit may be associated with a virtual, non-fiat currency.

### Exemplary Method for Processing Transactions in User Accounts

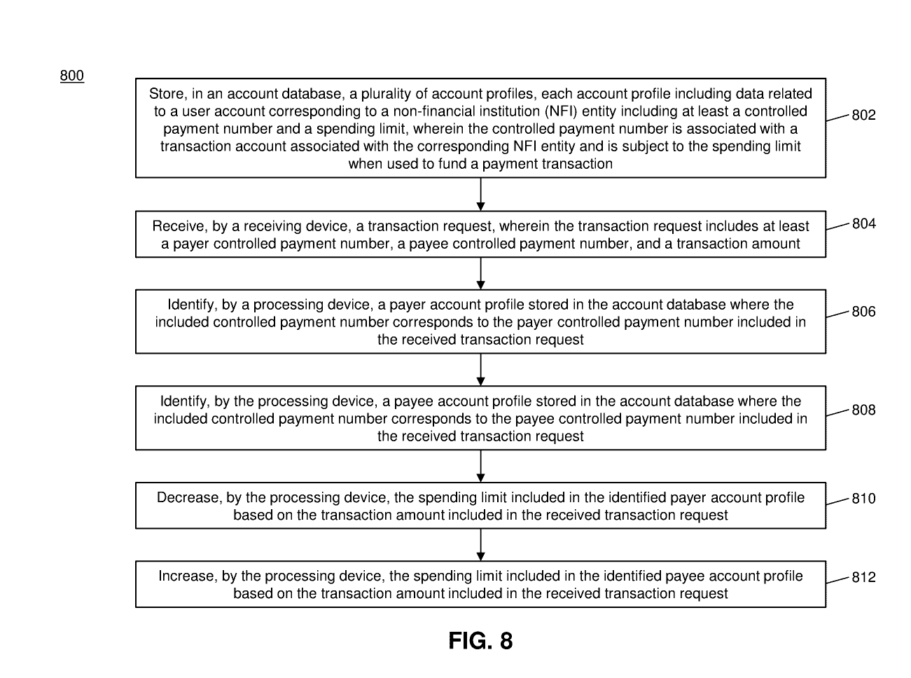

FIG. 8 illustrates a method 800 for the processing of user-to-user transactions for user accounts of an NFI entity 104 using CPNs.

In step 802, a plurality of account profiles (e.g., account profiles 210) may be stored in an account database (e.g., the account database 208), wherein each account profile 210 includes data related to a user account corresponding to a non-financial institution (NFI) entity (e.g., the NFI entity 104) including at least a controlled payment number (CPN) and a spending limit, and wherein the CPN is associated with a transaction account associated with the corresponding NFI entity and is subject to the spending limit when used to fund a payment transaction. In one embodiment, payment transactions involving a CPN included in a stored account profile 210 may be drawn against the associated transaction account.

In step 804, a transaction request may be received by a receiving device (e.g., the receiving unit 202), wherein the transaction request includes at least a payer CPN, a payee CPN, and a transaction amount. In some embodiments, the spending limit included in each account profile 210 and the transaction amount may be associated with a virtual, non-fiat currency. In step 806, a payer account profile 210 stored in the account database 208 may be identified by a processing device (e.g., the processing unit 204) where the included CPN corresponds to the payer CPN included in the received transaction request.

In step 808, a payee account profile 210 stored in the account database 208 may be identified by the processing device 204 where the included CPN corresponds to the payee CPN included in the received transaction request. In step 810, the spending limit included in the identified payer account profile 210 may be decreased by the processing device 204 based on the transaction amount included in the received transaction request. In step 812, the spending limit included in the identified payee account profile 210 may be increased by the processing device 204 based on the transaction amount included in the received transaction request.

In one embodiment, the transaction request may be a transaction message formatted based on one or more standards, and the transaction message may include a plurality of data elements including at least a first data element configured to store the payer CPN, a second data element configured to store the payee CPN, and a third data element configured to store the transaction amount. In a further embodiment, the transaction message may further include a message type indicator indicative of an authorization request. In another further embodiment, the method 800 may also include transmitting, by a transmitting device (e.g., the transmitting unit 206), a response message formatted based on the one or more standards in response to the received transaction request, wherein the response message may include a message type indicator indicative of an authorization response.

### Computer System Architecture

FIG. 9 illustrates a computer system 900 in which embodiments of the present disclosure, or portions thereof, may be implemented as computer-readable code. For example, the processing server 102 of FIG. 1 may be implemented in the computer system 900 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3A, 3B, 4A, 4B, and 5-7.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 918, a removable storage unit 922, and a hard disk installed in hard disk drive 912.

Various embodiments of the present disclosure are described in terms of this example computer system 900. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 904 may be a special purpose or a general purpose processor device. The processor device 904 may be connected to a communications infrastructure 906, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 900 may also include a main memory 908 (e.g., random access memory, read-only memory, etc.), and may also include a secondary memory 910. The secondary memory 910 may include the hard disk drive 912 and a removable storage drive 914, such as a floppy disk drive, a magnetic tape drive, an optical disk drive, a flash memory, etc.

The removable storage drive 914 may read from and/or write to the removable storage unit 918 in a well-known manner. The removable storage unit 918 may include a removable storage media that may be read by and written to by the removable storage drive 914. For example, if the removable storage drive 914 is a floppy disk drive or universal serial bus port, the removable storage unit 918 may be a floppy disk or portable flash drive, respectively. In one embodiment, the removable storage unit 918 may be non-transitory computer readable recording media.

In some embodiments, the secondary memory 910 may include alternative means for allowing computer programs or other instructions to be loaded into the computer system 900, for example, the removable storage unit 922 and an interface 920. Examples of such means may include a program cartridge and cartridge interface (e.g., as found in video game systems), a removable memory chip (e.g., EEPROM, PROM, etc.) and associated socket, and other removable storage units 922 and interfaces 920 as will be apparent to persons having skill in the relevant art.

Data stored in the computer system 900 (e.g., in the main memory 908 and/or the secondary memory 910) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 900 may also include a communications interface 924. The communications interface 924 may be configured to allow software and data to be transferred between the computer system 900 and external devices. Exemplary communications interfaces 924 may include a modem, a network interface (e.g., an Ethernet card), a communications port, a PCMCIA slot and card, etc. Software and data transferred via the communications interface 924 may be in the form of signals, which may be electronic, electromagnetic, optical, or other signals as will be apparent to persons having skill in the relevant art. The signals may travel via a communications path 926, which may be configured to carry the signals and may be implemented using wire, cable, fiber optics, a phone line, a cellular phone link, a radio frequency link, etc.

The computer system 900 may further include a display interface 902. The display interface 902 may be configured to allow data to be transferred between the computer system 900 and external display 930. Exemplary display interfaces 902 may include high-definition multimedia interface (HDMI), digital visual interface (DVI), video graphics array (VGA), etc. The display 930 may be any suitable type of display for displaying data transmitted via the display interface 902 of the computer system 900, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 908 and secondary memory 910, which may be memory semiconductors (e.g., DRAMs, etc.). These computer program products may be means for providing software to the computer system 900. Computer programs (e.g., computer control logic) may be stored in the main memory 908 and/or the secondary memory 910. Computer programs may also be received via the communications interface 924. Such computer programs, when executed, may enable computer system 900 to implement the present methods as discussed herein. In particular, the computer programs, when executed, may enable processor device 904 to implement the methods illustrated by FIGS. 3A, 3B, 4A, 4B, and 5-7, as discussed herein. Accordingly, such computer programs may represent controllers of the computer system 900. Where the present disclosure is implemented using software, the software may be stored in a computer program product and loaded into the computer system 900 using the removable storage drive 914, interface 920, and hard disk drive 912, or communications interface 924.

Techniques consistent with the present disclosure provide, among other features, systems and methods for processing user account transactions using controlled payment numbers. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for providing credit for a user account, comprising:
storing, in an account database, a plurality of account profiles, each account profile including data related to a user account of a non-financial institution (NFI) entity, said data including at least a controlled payment number and a spending limit, wherein the controlled payment number is associated with a transaction account of the corresponding NFI entity and is subject to the spending limit when used to fund a payment transaction;
receiving, by a receiving device, a transaction message for a payment transaction, wherein the transaction message is formatted based on one or more payment network standards and includes a plurality of data elements including at least a first data element configured to store a transaction account number associated with the transaction account of the corresponding NFI entity and a second data element configured to store a transaction amount;
identifying, by a processing device, a specific account profile stored in the account database; and
increasing, by the processing device, the spending limit included in the identified specific account profile based on the transaction amount of the second data element included in the received transaction message.

2. The method of claim 1, wherein
the transaction message further includes a third data element configured to store a transaction account number associated with a payer, and
the method further comprises:
processing, by the processing device, the payment transaction for payment of the transaction amount from a transaction account associated with the transaction account number associated with the payer to the transaction account associated with the corresponding NFI entity.

3. The method of claim 2, further comprising:
transmitting, by a transmitting device, a response message formatted based on the one or more payment network standards in response to the received transaction message based on a result of the processing of the payment transaction.

4. The method of claim 1, wherein
the transaction message further includes a third data element configured to store a controlled payment number, and
the specific account profile is identified based on inclusion of a controlled payment number that corresponds to the controlled payment number stored in the third data element included in the received transaction message.

5. The method of claim 1, further comprising:
receiving, by the receiving device, an account adjustment request from an NFI entity, wherein the account adjustment request includes at least a specific controlled payment number associated with a transaction account associated with the NFI entity, wherein
the specific account profile is identified based on inclusion of the specific controlled payment number included in the received account adjustment request.

6. The method of claim 5, wherein
the account adjustment request further includes an adjustment amount based on the transaction amount stored in the second data element included in the received transaction message, and
the spending limit included in the identified specific account profile is increased by the adjustment amount included in the received account adjustment request.

7. The method of claim 6, wherein the adjustment amount and the spending limit are associated with a virtual, non-fiat currency.

8. The method of claim 1, wherein payment transactions involving a controlled payment number included in a stored account profile are drawn against the associated transaction account.

9. The method of claim 1, wherein the transaction message further includes a message type indicator indicative of an authorization request.

10. A method for processing transactions in user accounts, comprising:
storing, in an account database, a plurality of account profiles, each account profile including data related to a user account of a non-financial institution (NFI) entity, said data including at least a controlled payment number and a spending limit, wherein the controlled payment number is associated with a transaction account of the corresponding NFI entity and is subject to the spending limit when used to fund a payment transaction;
receiving, by a receiving device, a transaction request, wherein the transaction request includes at least a payer controlled payment number, a payee controlled payment number, and a transaction amount;
identifying, by a processing device, a payer account profile stored in the account database where the included controlled payment number corresponds to the payer controlled payment number included in the received transaction request;
identifying, by the processing device, a payee account profile stored in the account database where the included controlled payment number corresponds to the payee controlled payment number included in the received transaction request;
decreasing, by the processing device, the spending limit included in the identified payer account profile based on the transaction amount included in the received transaction request; and
increasing, by the processing device, the spending limit included in the identified payee account profile based on the transaction amount included in the received transaction request.

11. The method of claim 10, wherein payment transactions involving a controlled payment number included in a stored account profile are drawn against the associated transaction account.

12. The method of claim 10, wherein
the transaction request is a transaction message formatted based on one or more standards, and
the transaction message includes a plurality of data elements including at least a first data element configured to store the payer controlled payment number, a second data element configured to store the payee controlled payment number, and a third data element configured to store the transaction amount.

13. The method of claim 12, wherein the transaction message further includes a message type indicator indicative of an authorization request.

14. The method of claim 12, further comprising:
transmitting, by a transmitting device, a response message formatted based on the one or more standards in response to the received transaction request, wherein the response message includes a message type indicator indicative of an authorization response.

15. The method of claim 10, wherein the spending limit included in each account profile and the transaction amount are associated with a virtual, non-fiat currency.

16. A system for providing credit for a user account, comprising:
an account database configured to store a plurality of account profiles, each account profile including data related to a user account of a non-financial institution (NFI) entity, said data including at least a controlled payment number and a spending limit, wherein the controlled payment number is associated with a transaction account of the corresponding NFI entity and is subject to the spending limit when used to fund a payment transaction;
a receiving device configured to receive a transaction message for a payment transaction, wherein the transaction message is formatted based on one or more payment network standards and includes a plurality of data elements including at least a first data element configured to store a transaction account number associated with the transaction account of the corresponding NFI entity and a second data element configured to store a transaction amount; and
a processing device configured to
identify a specific account profile stored in the account database, and
increase the spending limit included in the identified specific account profile based on the transaction amount stored in the second data element included in the received transaction message.

17. The system of claim 16, wherein
the transaction message further includes a third data element configured to store a transaction account number associated with a payer, and
the processing device is further configured to process the payment transaction for payment of the transaction amount from a transaction account associated with the transaction account number associated with the payer to the transaction account associated with the corresponding NFI entity.

18. The system of claim 17, further comprising:
a transmitting device configured to transmit a response message formatted based on the one or more payment network standards in response to the received transaction message based on a result of the processing of the payment transaction.

19. The system of claim 16, wherein
the transaction message further includes a third data element configured to store a controlled payment number, and
the specific account profile is identified based on inclusion of a controlled payment number that corresponds to the controlled payment number stored in the third data element included in the received transaction message.

20. The system of claim 16, wherein
the receiving device is further configured to receive an account adjustment request from an NFI entity,
the account adjustment request includes at least a specific controlled payment number associated with a transaction account associated with the NFI entity, and
the specific account profile is identified based on inclusion of the specific controlled payment number included in the received account adjustment request.

21. The system of claim 20, wherein
the account adjustment request further includes an adjustment amount based on the transaction amount stored in the second data element included in the received transaction message, and
the spending limit included in the identified specific account profile is increased by the adjustment amount included in the received account adjustment request.

22. The system of claim 21, wherein the adjustment amount and the spending limit are associated with a virtual, non-fiat currency.

23. The system of claim 16, wherein payment transactions involving a controlled payment number included in a stored account profile are drawn against the associated transaction account.

24. The system of claim 16, wherein the transaction message further includes a message type indicator indicative of an authorization request.

25. A system for processing transactions in user accounts, comprising:
an account database configured to store a plurality of account profiles, each account profile including data related to a user account of a non-financial institution (NFI) entity, said data including at least a controlled payment number and a spending limit, wherein the controlled payment number is associated with a transaction account of the corresponding NFI entity and is subject to the spending limit when used to fund a payment transaction;
a receiving device configured to receive a transaction request, wherein the transaction request includes at least a payer controlled payment number, a payee controlled payment number, and a transaction amount; and
a processing device configured to
identify a payer account profile stored in the account database where the included controlled payment number corresponds to the payer controlled payment number included in the received transaction request,
identify a payee account profile stored in the account database where the included controlled payment number corresponds to the payee controlled payment number included in the received transaction request,
decrease the spending limit included in the identified payer account profile based on the transaction amount included in the received transaction request, and
increase the spending limit included in the identified payee account profile based on the transaction amount included in the received transaction request.

26. The system of claim 25, wherein payment transactions involving a controlled payment number included in a stored account profile are drawn against the associated transaction account.

27. The system of claim 25, wherein
the transaction request is a transaction message formatted based on one or more standards, and
the transaction message includes a plurality of data elements including at least a first data element configured to store the payer controlled payment number, a second data element configured to store the payee controlled payment number, and a third data element configured to store the transaction amount.

28. The system of claim 27, wherein the transaction message further includes a message type indicator indicative of an authorization request.

29. The system of claim 27, further comprising:
a transmitting device configured to transmit a response message formatted based on the one or more standards in response to the received transaction request, wherein the response message includes a message type indicator indicative of an authorization response.

30. The system of claim 25, wherein the spending limit included in each account profile and the transaction amount are associated with a virtual, non-fiat currency.
